(19) United States
(12) Patent Application Publication
(10) Pub. No.: US 2006/0260341 A1
(43) Pub. Date: Nov. 23, 2006

(54) Refrigerator with integrated air cleaner

(76) Inventor: Dan Meyvis, Bloomfield Hills, MI (US)

Correspondence Address: YOUNG & BASILE, P.C., 3001 WEST BIG BEAVER ROAD, SUITE 624, TROY, MI, 48084, US

(21) Appl. No.: 11/431,480

(22) Filed: May 10, 2006

Related U.S. Application Data
(60) Provisional application No. 60/682,739, filed on May 19, 2005.

(51) Int. Cl. B01D 46/00; B01D 50/00; F25D 23/12; F25D 11/00; B01D 39/00; B01D 59/50

(52) U.S. Cl. 62/331; 62/440; 96/224; 55/318; 55/385.1

(57) ABSTRACT

A refrigerator with a built in air cleansing system. The system includes a plurality of intake vents provided at spaced locations in the refrigerator housing and exposed to the environment, a plurality of disparate filters positioned in the refrigerator housing, a plurality of exhaust vents provided in the refrigerator housing at spaced locations and exposed to the environment, intake ducting extending within the housing from the intake vents to the filters, exhaust ducting extending within the housing from the filters to the exhaust vents, and a fan positioned in the housing and operative to draw environmental air in through the intake vents, route it to the filters through the intake ducting, and route the filtered air through the exhaust ducting to the exhaust vents for discharge to the environment.

### BACKGROUND

Air filters for home use has been known for many years. These typically have been applied either directly on the home heating or air conditioning system or as an air filter over or near a cook top or as a stand-alone filter system.

In kitchens the current filter systems have been generally inadequate to handle the spike in polluted air volume due to cooking and food preparation. The “over the stove” units have been either undersized, noisy, or of a type that is inadequate to cleanse the particular pollutants generated in the kitchen by cooking or food preparation or the presence of other pollutants or pathogens that may be found in the kitchen environment. It is generally inconvenient to bring in a stand-alone air cleaner to handle the spikes in air pollution in the kitchen. Additionally such stand alone cleaners are generally noisy, take up space in the kitchen, and sometimes do not provide an adequate cleaning mechanism for the kitchen pollution.

### SUMMARY OF THE INVENTION

This invention is directed to the provision of an improved air cleansing system.

More particularly this invention is directed to the provision of an improved air cleansing system that forms an integral part of an existing refrigerator.

The invention is applicable to a refrigerator including a refrigerant cycle apparatus and a housing including a main body casing and a door assembly mounted on the casing and coacting with the casing to define a refrigeration compartment accessible with the door assembly in an open position.

According to the invention, the refrigerator further includes an environmental air cleansing system including an intake vent provided in the housing and exposed to the environment, a filter positioned in the housing, an exhaust vent provided in the housing and exposed to the environment, intake ducting extending within the housing from the intake vent to the filter, exhaust ducting extending within the housing from the filter to the exhaust vent, and a fan positioned in the housing and operative to draw environmental air in through the intake vent, route it to the filter through the intake ducting, and route the filtered air through the exhaust ducting to the exhaust vent for discharge to the environment.

According to a further feature of the invention, the intake vent is positioned in the door assembly.

According to a further feature of the invention, the exhaust vent is also positioned in the door assembly.

According to a further feature of the invention, the filter is also positioned in the door assembly.

According to a further feature of the invention, there are a plurality of intake vents positioned in spaced relation in the door assembly.

According to a further feature of the invention, there are a plurality of exhaust vents positioned in spaced relation in the door assembly.

According to a further feature of the invention, there are a plurality of filters positioned in the door assembly.

According to a further feature of the invention, one filter is a HEPA filter.

According to a further feature of the invention, one filter is a carbon filter.

According to a further feature of the invention, one filter is a UV light filter.

According to a further feature of the invention, the door assembly has a rectangular configuration including door assembly edges and the intake vent and the exhaust vent are positioned in spaced relation in the door assembly edges.

According to a further feature of the invention, the door assembly comprises two side by side doors; the intake vent is positioned in an edge of one of the doors; the exhaust vent is positioned in an edge of the other of the doors; the filter is positioned in the other door; and the intake conduit extends from the intake filter, through the one door, through the main body casing, and through the other door to the filter.

The invention also discloses a methodology for utilizing an existing refrigerator to provide an air cleansing system for the associated environment.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is an exploded view of a standard side by side refrigerator;

FIG. 2 is a perspective view of a side by side refrigerator incorporating an air cleansing system according to the invention;

FIGS. 3 and 4 are left side and right side elevational views of the refrigerator;

FIG. 5 is a perspective view of the refrigerator;

FIG. 6 is a detail view of filters utilized in the air cleansing system;

FIG. 7 is a further perspective view of the refrigerator;

FIG. 8 is a detail view of a control panel utilized in the refrigerator;

FIG. 9 is a top view of the refrigerator;

FIG. 10 is a cross-sectional view of the refrigerator taken on line 10-10 of FIG. 2; and

FIG. 11 is a perspective view of a small cube refrigerator incorporating an air cleansing system according to the invention.

### DETAILED DESCRIPTION OF THE PREFERRED EMBODIMENTS

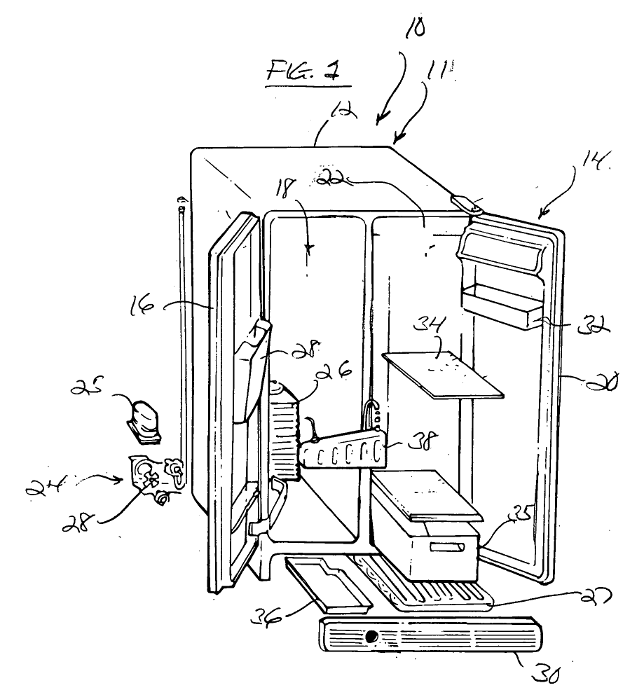

The invention air cleansing system is intended to form an integral part of an existing refrigerator system. One such refrigerator, of the well known side by side type, is seen in FIG. 1. The side by side refrigerator 10 of FIG. 1 includes a housing 11 including a main body casing 12 and a door assembly 14 including a left door 16 coacting with the casing to define a freezer compartment 18 and a right door 20 coacting with the casing to define a refrigerator compartment 22. The refrigerator of FIG. 1 further includes, in known manner, a refrigerant cycle apparatus 23. Apparatus 23 includes a compressor 25, an evaporator 26, a condenser 27, and an expansion valve (not shown) and may also include a motor driven condenser fan 28 positioned to draw air in through a lower grill 30. Refrigerator 10 may also include appropriate shelving 32 in the doors 16, 18, casing shelves 34, bins 35, a drip pan 36, and a water reservoir 38.

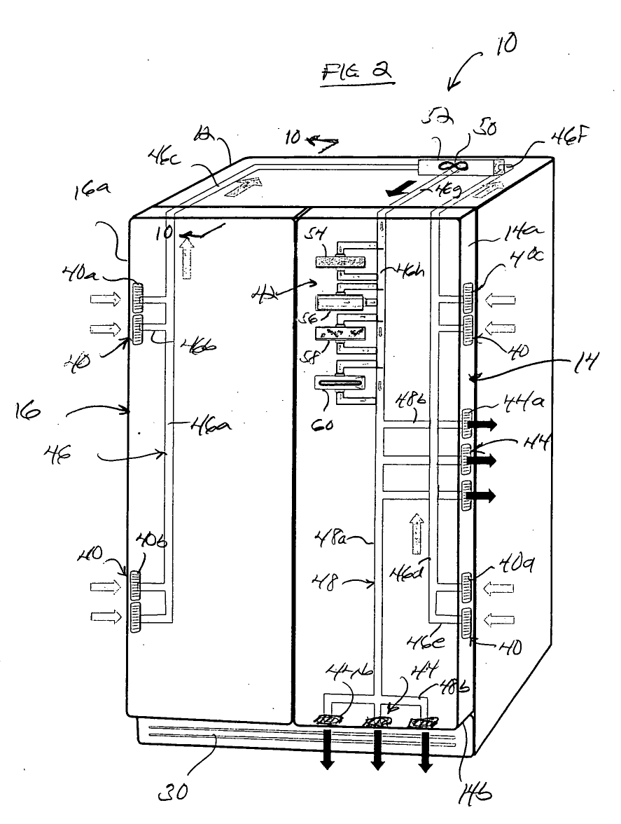

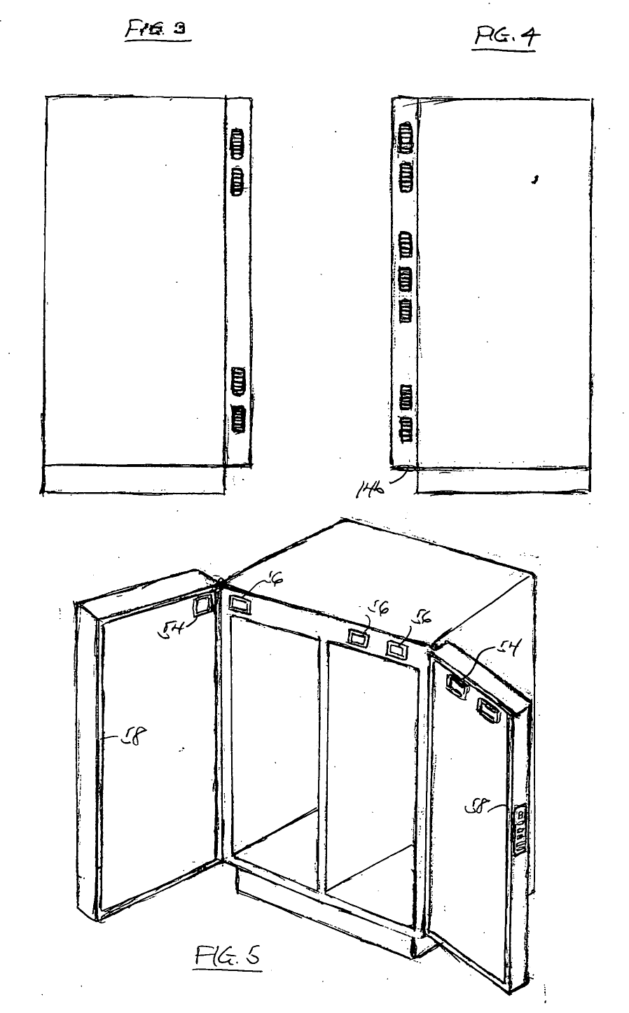

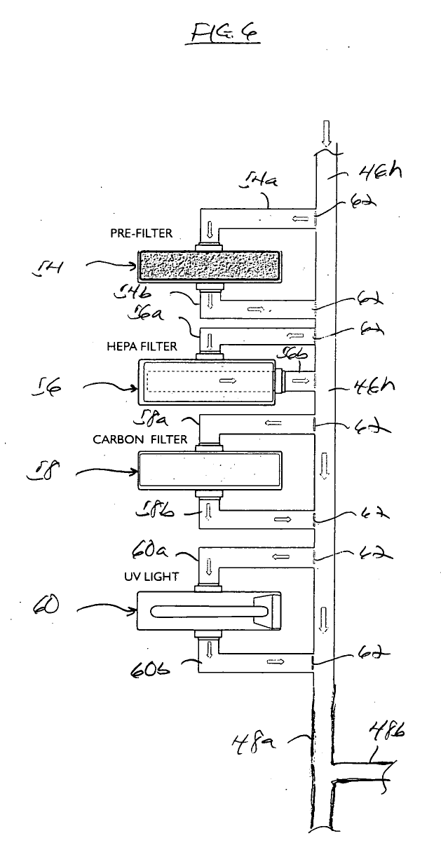

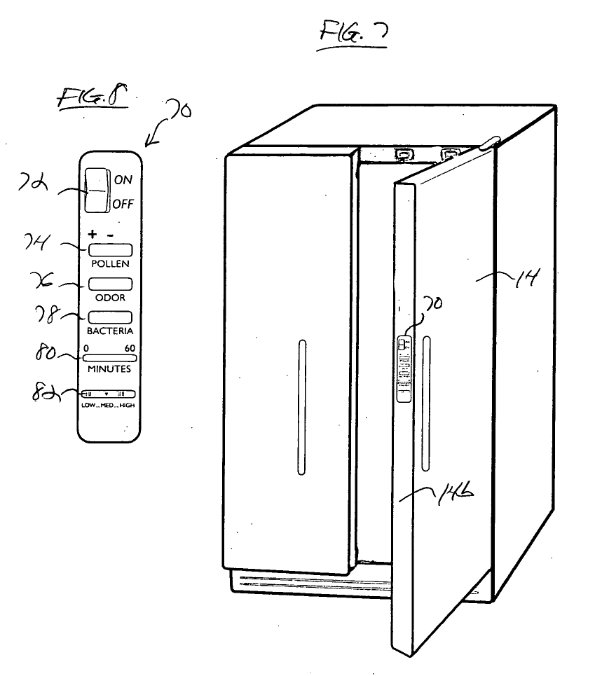

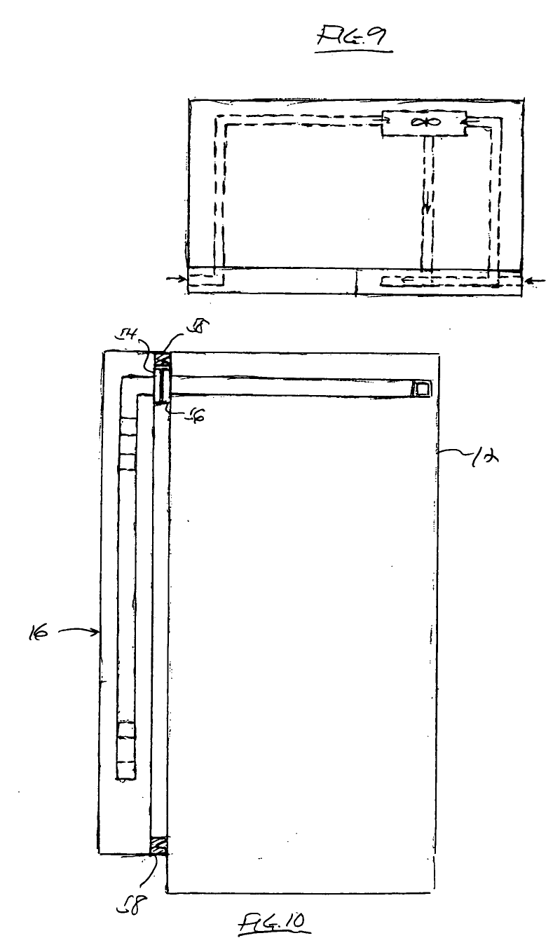

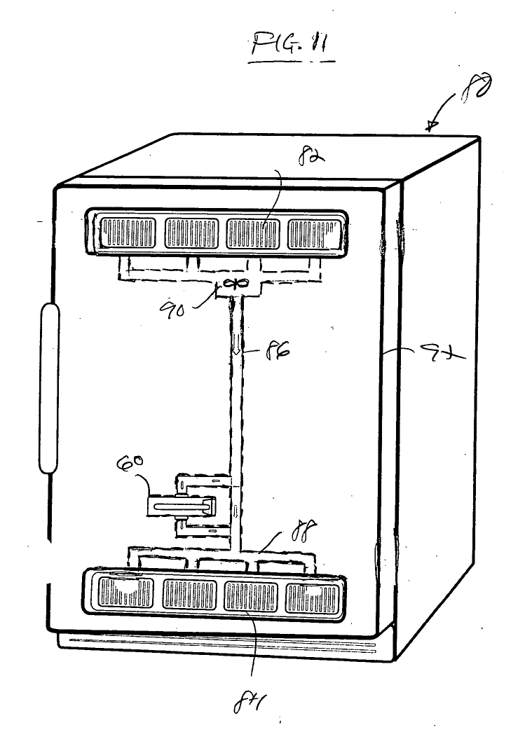

The side by side refrigerator 10 of FIG. 1 is seen in FIGS. 2-10 equipped with an integral environmental air cleansing system according to the invention.

The air cleansing system, broadly considered, includes a plurality of intake vents 40, a plurality of filters 44, a plurality of exhaust vents 44, intake ducting 46 extending within the housing from the intake vents to the filters, exhaust ducting 48 extending within the housing from the filters to the exhaust vents, and a fan 50 positioned in the housing and operative to draw environmental air in through the intake vents, route it to the filter through the filters for the intake ducting, and route the filtered air through the exhaust ducting to the exhaust vents for discharge to the environment.

Intake vents may be provided for example in the left edge 16a of door 16 in vertically spaced relation and in the right edge 14a of door 14 in vertically spaced relation. For example, two intake vents 40a may be provided in the upper region of edge 16a; two intake vents 40b may be provided in the lower region of edge 16a; two intake vents 40c may be provided in the upper region of edge 14a; and two intake vents 40d may be provided in the lower region of edge 14a.

A plurality of exhaust vents 44a may be provided in edge 14a intermediate inlet vents 40c and 40d and a plurality of exhaust vents 44b may be provided in the lower edge 14b of door 14.

Intake ducting 46 may comprise any suitable ducting or tubing and includes a vertical conduit run 46a in door 16; a plurality of connector conduits 46b in door 16 interconnecting respective intake vents 40a/40b to conduit 46a; a conduit 46c in the top wall 12a of main body casing 12 communicating with one end of a plenum 52 positioned proximate the rear edge of the casing top wall 12a; a vertical conduit 46d in door 14; a plurality of connector conduits 46e connecting the respective intake vents 40c and 40d to conduit 46d; a conduit 46f in casing top wall 12a connecting to an opposite end of plenum 52; a conduit 46g in casing top wall 12a communicating with plenum 52; and a vertical conduit 46h in door 14 communicating with filters 42.

Conduits 46a and 46c, 46d and 46f, and 46g and 46h sealingly communicate at the respective interfaces between the doors 14 and 16 and the main body casing utilizing resilient door seal members 54 sealingly coacting with resilient main body seal members 56. Door seal members 54 may be positioned, for example, immediately inboard of the known peripheral seal member 58 of the respective doors.

Exhaust ducting 48 may include a vertical conduit 48a in door 14 communicating at its upper end with the lower end of intake conduit 46h and a plurality of connector conduits 48b extending between conduit 48a and the respective exhaust vents 44a/44b.

Filters 42 may include, for example, a prefilter 54, a HEPA filter 56, a carbon filter 58, and a UV light filter 60.

Each filter includes an inlet conduit 54a, 56a, 58a, 60a, and an exhaust conduit 54b, 56b, 58b and 60b, for communication with inlet conduit 46h, and a flap valve 62 of known form is provided at the juncture of each conduit 54a, 54b, 56a, 56b, 58a, 58b, 60a and 60b with inlet conduit 46h. It will be seen that by selective movement of the valves 62 the environmental air arriving at the filters via inlet conduit 46h may be selectively routed through one or more of the filters.

Fan 50 is positioned in plenum 52 and is operative to draw environmental air in through the intake vents 40, route the air to the filters 42 through the intake ducting 46, and route the filtered air through the exhaust ducting 48 to the exhaust vents 44 for discharge to the environment. Although a separate fan 50 is shown for operation of the air cleansing system, it will be understood that in certain applications the existing condenser fan 28 may be employed as the operative fan in the system, replacing and/or augmenting the separate fan 50.

A control panel 70 is provided to selectively determine when the air cleansing system will be operational and which filters will be employed at any given time during the operation of the system.

For example, control panel 70 may be positioned in the left edge 14b of door 14 and may include an on/off switch 72, a pollen control switch 74, an odor switch 76, a bacteria switch 78, a timer 80 and an operating level switch 82. On/off switch 72 allows manual operation of the system. Selective operation of switches 74, 76 and 78 selectively determines which filters will be operational and specifically controls the respective flap valves 62 associated with the respective filters to provide the filter combination called for by the switch selection. Timer 80 determines how long this system will be operational and the switch 82 determines at what level (low, medium, high) the system will be operated.

The integral air cleansing system of the invention, whether operated manually utilizing switch 72 or operative in response to a predetermined program, provides an effective means of cleansing the air in the room or other environment in which the refrigerator is located. The air cleaning system of the invention will clean, filter and otherwise purify air that is in proximity to the refrigerator. The system can be specifically arranged to filter particulate and gasses or to kill pathogens. Possible filters include HEPA filters, carbon filters, electrostatic precipitators (electronic air cleaner), UV light filters and temperature filters. Filter combinations may also include pre-filters and carbon filters to change ozone produced by an electrostatic filter back to oxygen.

The provision of the air cleansing system as an integral part of the refrigerator allows the system to use the large linear dimensions and surface area of the refrigerator to provide effective filtering operation and also to control noise. Specifically, the refrigerator allows the intake air to be inlet into the system at spaced points ranging from locations near the floor of the room to near the ceiling of the room, similarly allows the filtered air to be exhausted into the environment at locations ranging from near the floor to near the ceiling, and allows the motor/fan of the system to be positioned proximate the rear face of the refrigerator where noise will be minimized.

Use of the refrigerator as the base for the cleansing system also allows the use of the supply power and electronic control circuitry of the refrigerator to facilitate the operation of the air cleansing system.

The specific location of the filters within the refrigerator and the specific order in which the filters are provided will of course vary depending upon the envisioned application. The filters should also be arranged so as to be easily removable and washable and the washing of the filters may be accomplished utilizing an existing water supply of the refrigerator.

As noted, the control panel 70 allows for precisely selected operational modes of the system. For example, the control panel can be utilized to control the volume of air and the time duration of the air to be cleaned. A particular cleaning function may be preset to occur each day during certain time periods, and/or the cleaning function might be automatically activated for typical meal preparation times during the day. Further, sensors could be provided that would detect oil or gasses in the air and/or count the number of times the refrigerator door opens in a select period of time to selectively activate the system. As noted, sound control is maintained by placement of the fan or fans either to the back of the refrigerator housing or in an isolated housing compartment within the refrigerator. Although the movement of the air between the doors and the main body housing casing are shown as being accomplished utilizing coacting resilient seals 54, 56, it will be understood that other means might be utilized to achieve this interface such for example as collapsible hose connectors between the casing and the doors.

The programmable sequence of air cleaning can be set either as a time of day event, activated by the quantification of opening and closing the refrigerator door, or by sensors that detect oil particles in the air or the presence of other pollutants. The mechanical and programmable functions could operate independently of each other. The UV light could operate in the early morning hours before the kitchen is occupied while the carbon filter could be mechanically activated during the cooking time period.

The refrigerator 80 seen in FIG. 11 is a small cube refrigerator commonly found in college dorm rooms. In this refrigerator the intake vents 82, the exhaust vents 84, the intake ducting 86, the exhaust ducting 88, and the fan 90 are all positioned in the single refrigerator door 92 and only a single UV light filter 60 is employed, also positioned in the door. This refrigerator would be operative to kill airborne pathogens in the confines of the dormitory room and the UV light filter 60 would be programmable or sensor controlled. One possible sensor would be a passive infrared detector that would activate the UV light when a person is detected in the dormitory room.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A refrigerator including a refrigerant cycle apparatus and a housing including a main body casing and a door assembly mounted on the casing and coacting with the casing to define a refrigeration compartment accessible with the door assembly in an open position, characterized in that:
the refrigerator further includes an environmental air cleansing system including an intake vent provided in the housing and exposed to the environment, a filter positioned in the housing, an exhaust vent provided in the housing and exposed to the environment, intake ducting extending within the housing from the intake vent to the filter, exhaust ducting extending within the housing from the filter to the exhaust vent, and an air moving device positioned in the housing and operative to draw environmental air in through the intake vent, route it to the filter through the intake ducting, and route the filtered air through the exhaust ducting to the exhaust vent for discharge to the environment.

2. A refrigerator according to claim I wherein the intake vent is positioned in the door assembly.

3. A refrigerator according to claim I wherein the exhaust vent is positioned in the door assembly.

4. A refrigerator according to claim I wherein the intake vent and the exhaust vent are positioned in the door assembly.

5. A refrigerator according to claim 4 wherein the filter is positioned in the door assembly.

6. A refrigerator according to claim 2 wherein there are a plurality of intake vents positioned in spaced relation in the door assembly.

7. A refrigerator according to claim 3 wherein there are a plurality of exhaust vents positioned in spaced relation in the door assembly.

8. A refrigerator according to claim 5 wherein there are a plurality of filters positioned in the door assembly.

9. A refrigerator according to claim 8 wherein one filter is a HEPA filter.

10. A refrigerator according to claim 8 wherein one filter is a carbon filter.

11. A refrigerator according to claim 8 wherein one filter is a UV light filter.

12. A refrigerator including:
a refrigerant cycle apparatus;
a housing including a main body casing and a door assembly mounted on the casing and coacting with the casing to define a refrigeration compartment accessible with the door assembly in an open position; and
an integral environmental air cleansing system including an intake vent provided in the housing and exposed to the environment, a filter positioned in the housing, an exhaust vent provided in the housing and exposed to the environment, intake ducting extending within the housing from the intake vent to the filter, exhaust ducting extending within the housing from the filter to the exhaust vent, and means operative to draw environmental air in through the intake vent, route it to the filter through the intake ducting, and route the filtered air through the exhaust ducting to the exhaust vent for discharge to the environment.

13. A refrigerator according to claim 12 wherein the operative means comprises a fan positioned in the housing.

14. A refrigerator according to claim 12 wherein:
the door assembly has a rectangular configuration including door assembly edges; and
the intake vent and the exhaust vent are positioned in spaced relation in the door assembly edges.

15. A refrigerator according to claim 13 wherein the filter is positioned in the door assembly.

16. A refrigerator according to claim 15 wherein:
the door assembly comprises two side by side doors;
the intake vent is positioned in an edge of one of the doors;
the exhaust vent is positioned in an edge of the other of the doors;
the filter is positioned in the other door; and
the intake conduit extends from the intake filter, through the one door, through the main body casing, and through the other door to the filter.

17. For use with a refrigerator including a refrigerant cycle apparatus and a housing including a main body casing and a door assembly mounted on the casing and coacting with the casing to define a refrigeration compartment accessible with the door assembly in an open position, a method of utilizing the refrigerator to provide an air cleansing system for the associated environment, the method comprising:
providing an intake vent in the housing exposed to the environment;
positioning a filter in the housing;
providing an exhaust vent in the housing exposed to the environment;
providing intake ducting extending within the housing from the intake vent to the filter;
providing exhaust ducting extending within the housing from the filter to the exhaust vent; and
providing means operative to draw environmental air in through the intake vent, route the air to the filter through the intake ducting, and route the filtered air through the exhaust ducting to the exhaust vent for discharge to the environment.

18. A method according to claim 17 wherein the step of providing operative means comprises providing a fan in the housing operative to route the air.

19. A method according to claim 17 wherein:
a plurality of filters of disparate function are provided; and
the method includes the further step of providing control means to selectively route the air to one or more of the disparate filters.

20. A method according to claim 19 wherein the control means includes means operative to energize the air cleansing system either mechanically or in response to a predetermined program.
